(19) United States
(12) Patent Application Publication
(10) Pub. No.: US 2010/0067685 A1
(43) Pub. Date: Mar. 18, 2010

(54) ENCRYPTION DEVICE

(76) Inventor: Yoshitaka Okita, Osaka-shi (JP)

Correspondence Address: BIRCH STEWART KOLASCH & BIRCH, PO BOX 747, FALLS CHURCH, VA, 22040-0747, US

(21) Appl. No.: 12/447,345

(22) PCT Filed: Aug. 13, 2007
(86) PCT No.: PCT/JP2007/065810

§ 371 Date: Apr. 27, 2009

(30) Foreign Application Priority Data
Oct. 30, 2006 (JP) 2006-293873

(51) Int. Cl. H04L 9/28; G06F 1/04; G06F 1/26

(52) U.S. Cl. 380/28; 713/500; 713/300

(57) ABSTRACT

Provided is an encryption device with enhanced function to prevent an encryption key from being decrypted by consumption current analysis, by complicating alignment of consumption current waveforms. The encryption device comprises a clock control circuit adapted to receive a clock signal and a pseudo-random number, and perform a suspend process and a resume process to the clock signal based on the pseudo-random number to generate an encryption processor clock signal; an encryption processor adapted to perform an encryption process to encryption target data in synchronization with the encryption processor clock signal; and a current control circuit adapted to obtain an arithmetic state showing an operational state of the encryption processor to adjust a consumption current amount based on the arithmetic state.

### CROSS-REFERENCE TO RELATED APPLICATIONS

This application is a National Phase filing under 35 U.S.C. § 371 of International Application No. PCT/JP2007/065810 filed on Aug. 13, 2007, and which claims priority to Japanese Patent Application No. 2006-293873 filed on Oct. 30, 2006.

### TECHNICAL FIELD

The present invention relates to an encryption device with enhanced function to prevent an encryption key from being decrypted by consumption current analysis.

### BACKGROUND ART

Since information networking has been advanced nowadays, information has a great value and accordingly, the security for the information is getting important. According to the security, “encryption technique” that aims to hide the information is positioned as one of the core techniques among various security techniques.

The encryption designates specific symbol and character or its procedure and system arranged so that the contents thereof cannot be understood by outsiders but understood by parties concerned, in which a sender converts (encrypts) an original sentence (plain sentence) to be transmitted to an encrypted sentence and transmits it to a receiver, and the receiver who received the encrypted sentence reconverts (decrypts) the encrypted sentence to the original sentence, whereby the contents can be recognized at last.

There are two main types of encryption systems such as a common key system and a public key system. The common key system is a system in which data encryption and decryption are performed by use of the same encryption key called a common key, such as DES (Data Encryption Standard). In addition, the public key system is a system in which data encryption and decryption are performed by use of different encryption keys called a public key and a secret key, as typified by, for example, a system called RSA (Rivest, Shamir, Adleman).

Although it is to be assumed that the thus encrypted contents cannot be recognized by a third person, it is a fact that a decryption technique has been advanced as the information technique has been advanced recently.

The decryption method includes a method (Brute Force system) in which every possible combination is tried, a method (Short Cut system) in which a solution is sought mathematically, and a method (side-channel system) in which characteristics of hardware such as a device is used. Among them, the side-channel system becomes intimidating as a new attack method with the advances in precise measurement technique.

As representative examples of the side-channel system, there are SPA (Simple Power Analysis) and DPA (Differential Power Analysis) in which the fact that the consumption power is increased at the time of encrypting operation is focused on and the encryption key is decrypted in an IC chip having an encryption processor from the consumption current at the time of encrypting operation.

For example, when the plain sentence is encrypted with the encryption key by RSA algorithm, a repeat operation corresponding to the bit number of the encryption key is performed. Since the operation sequence varies depending on whether the bit of the encryption key is 0 or 1 in each repeat operation, the encryption key could be decrypted by analyzing the consumption current.

To deal with the above attack, according to a conventionally disclosed technique, the information security is ensured by superimposing a random noise current on the consumption current during the operation to prevent the encryption key from being decrypted by the analysis of the consumption power (refer to Patent Document 1, for example).

When the attacking method is implemented by the consumption current analysis such as the SPA and DPA, it is necessary to perform an alignment operation in which the consumption current waveforms are superimposed. However, according to the method disclosed in Patent

Document 1, since an encryption process circuit operates in synchronization with a master clock signal and the noise current is superimposed in synchronization with the master clock signal, in the case where the encrypting operations are performed several times with the same encryption key and plain sentence, although the consumption current varies at random, the operation time is constant, so that the alignment operation can be easy. In addition, when the consumption current is repeatedly measured with the same encryption key and plain sentence, only the random noise current component could be removed by averaging their consumption current waveforms, so that the countermeasures against the consumption current analysis could not been satisfactorily achieved.

Patent Document 1: Japanese Unexamined Patent Publication No. 2005-252705

### DISCLOSURE OF THE INVENTION

The present invention is made in view of the above problems and it is an object of the present invention to provide an encryption device with enhanced function to prevent an encryption key from being decrypted by consumption current analysis, by complicating alignment of consumption current waveforms.

An encryption device according to the present invention to achieve the above object is characterized as a first characteristic by comprising: a clock control circuit adapted to receive a clock signal and a pseudo-random number, and perform a suspend process and a resume process to the clock signal based on the pseudo-random number to generate an encryption processor clock signal; an encryption processor adapted to perform an encryption process to encryption target data in synchronization with the encryption processor clock signal; and a current control circuit adapted to obtain an arithmetic state showing an operational state of the encryption processor to adjust a consumption current amount based on the arithmetic state.

According to the encryption device having the first characteristic in the present invention, since the encryption processor performs the encryption process in synchronization with the encryption processor clock signal generated by performing the suspend process and the resume process to the clock signal, the timing to execute the encryption process is not constant and varies depending on the encryption processor clock signal. Therefore, the timing when the consumption current amount is adjusted by the current control circuit varies depending on the timing of the encryption process. Especially, when the encryption processor clock signal is generated based on the pseudo-random number, since the timing of the encryption process varies at random, even when the same encryption target data is encrypted, its operation process time is not the same, whereby it is difficult to estimate the generation timing of the suspend even when the variation of the consumption current amount is externally detected and the consumption current waveforms are aligned.

In addition, the encryption device having the first characteristic according to the present invention is characterized as a second characteristic in that the clock control circuit determines a suspend length and suspend generation provability of the clock signal based on the pseudo-random number.

According to the encryption device having the second characteristic in the present invention, the encryption processor clock signal can be easily generated by varying the timing of the clock signal based on the value of the pseudo-random number.

In addition, the encryption device having the second characteristic according to the present invention is characterized as a third characteristic in that the clock control circuit receives a security level of the encryption target data, and changes one or both determination methods of the suspend length and the suspend generation provability depending on the security level.

According to the encryption device having the third characteristic in the present invention, the deviation degree of the encryption processor clock signal from the clock signal can vary depending on the security level showing the importance of the encryption target data to be processed by the encryption processor. Therefore, for example, when the encryption target data is high in security level, the range of the possible values of the suspend length and/or the suspend generation provability is increased to complicate the timing to execute the encrypting operation process, so that the generation timing of the suspend can be further prevented from being estimated.

In addition, when the security level is lowest, that is, when the security needs not to be ensured, the encryption processor clock signal may be generated under the condition that the suspend generation provability is 0%, that is, without generating the suspend at all.

In addition, the encryption device having any one of the above first to third characteristics according to the present invention is characterized as a fourth characteristic by further comprising a clock selection circuit adapted to output the clock signal, wherein the clock selection circuit receives a reference system clock signal and the pseudo-random number, includes one or more selecting clock generation circuits adapted to generate an original selecting clock signal different from the system clock signal in response to the system clock signal or regardless of it, selects any one signal from the one or more selecting clock signals and the system clock signal based on the pseudo-random number, and outputs it as the clock signal.

According to the encryption device having the fourth characteristic in the present invention, since the clock signal to be inputted to the clock control circuit is selected based on the pseudo-random number, the clock signal varies at random based on the pseudo-random number every time the clock selection circuit selects the clock signal and does not vary under the same or constant rule, so that the timing when the consumption current is increased can vary from moment to moment in the encryption device as a whole. Thus, even when the variation of the consumption current amount (or consumption power) is analyzed over a long period of time and the consumption current waveforms are aligned, it is difficult to estimate the generation timing of the suspend. In addition, the clock selection circuit may select the clock signal every time the encryption device is driven. In this case, when the encryption processor receives an encryption processor enable signal to switch between the operation and non-operation of the encryption processor, a configuration may be such that the encryption processor enable signal is inputted to the clock selection circuit, and the clock selection circuit selects the clock signal based on the pseudo-random number latched in response to the raise of the encryption processor enable signal.

At this time, the selecting clock generation circuit may be an oscillator that can generate a signal different in frequency characteristic from the system clock signal regardless of the system clock signal, or may be a frequency divider that can generate a signal different in frequency characteristic from the system clock signal by dividing the system clock signal, or may combine both of them.

In addition, the encryption device having the fourth characteristic according to the present invention is characterized as a fifth characteristic in that the clock selection circuit receives the security level, and signals any one of which is to be selected as the clock signal are determined based on the security level.

According to the encryption device having the fifth characteristic in the present invention, the number of candidate signals to be selected as the clock signal can vary depending on the security level showing the importance of the encryption target data to be processed by the encryption processor. For example, when the encryption target data is high in security level, one signal is selected as the clock signal from the system clock signal and all the selecting clock signals generated from the selecting clock generation circuit, and when the encryption target data is low in security level, one signal is selected as the clock signal from the system clock signal and one selecting clock signal generated from the predetermined selecting clock generation circuit, whereby the variation range of the clock signal can be increased based on the security level, and the more secured configuration can be provided.

In addition, the encryption device having any one of the above first to fifth characteristics according to the present invention is characterized as a sixth characteristic in that the current control circuit has a plurality of dummy cells each having a switching element, and the consumption current amount is adjusted by turning on the dummy cells a number of which is predetermined based on the arithmetic state.

According to the encryption device having the sixth characteristic in the present invention, the consumption current amount can be adjusted easily by controlling the switching between on and off.

In addition, the encryption device having any one of the above first to sixth characteristics according to the present invention is characterized as a seventh characteristic in that the current control circuit adjusts the consumption current amount based on the arithmetic state and an externally set adjustment amount.

According to the encryption device having the seventh characteristic in the present invention, since the adjustment range of the consumption current amount can be designated or changed by a user individually, the consumption current waveform can be further complicated, whereby it becomes further difficult to estimate the generation timing of the suspend.

In addition, the encryption device having any one of the above first to seventh characteristics according to the present invention is characterized as an eighth characteristic in that the current control circuit receives the pseudo-random number and adjusts the consumption current amount based on the arithmetic state and the value of the pseudo-random number.

According to the encryption device having the eighth characteristic in the present invention, the adjustment range of the consumption current amount can be designated or changed at random, and the consumption current waveform can be further complicated, so that it becomes further difficult to estimate the generation timing of the suspend.

According to the configuration of the present invention, since the timing of the encrypting operation process varies, even when the encryption target data is encrypted, its operation process time is not the same. Thus, even when the variation of the consumption current amount is externally detected and the consumption current waveforms are aligned, it is difficult to estimate the generation timing of the suspend, so that the encryption device with enhanced function to prevent the encryption key from being decrypted by the consumption current analysis can be implemented.

### BRIEF DESCRIPTION OF DRAWINGS

FIG. 1 is a block diagram showing a schematic configuration of an encryption device according to the present invention.

FIG. 2 is a timing chart showing a variation of each signal value according to the present invention.

FIG. 3 is a block diagram showing a schematic configuration of a clock selection circuit according to a second embodiment of the encryption device according to the present invention.

### EXPLANATION OF REFERENCES

1: Encryption device according to the present invention

2: Encryption processor

3: Clock control circuit

4: Current control circuit

5, 5a: Random number generation circuit

6: DCELL (dummy cell) group

7: Suspend signal generation circuit

8: DCELL switching signal generation circuit

9: Clock selection circuit

10: Clock selection signal generation circuit

11: Selector circuit

12: Selecting clock generation circuit

12a, 12b: Oscillator (one example of selecting clock generation circuit)

### BEST MODE FOR CARRYING OUT THE INVENTION

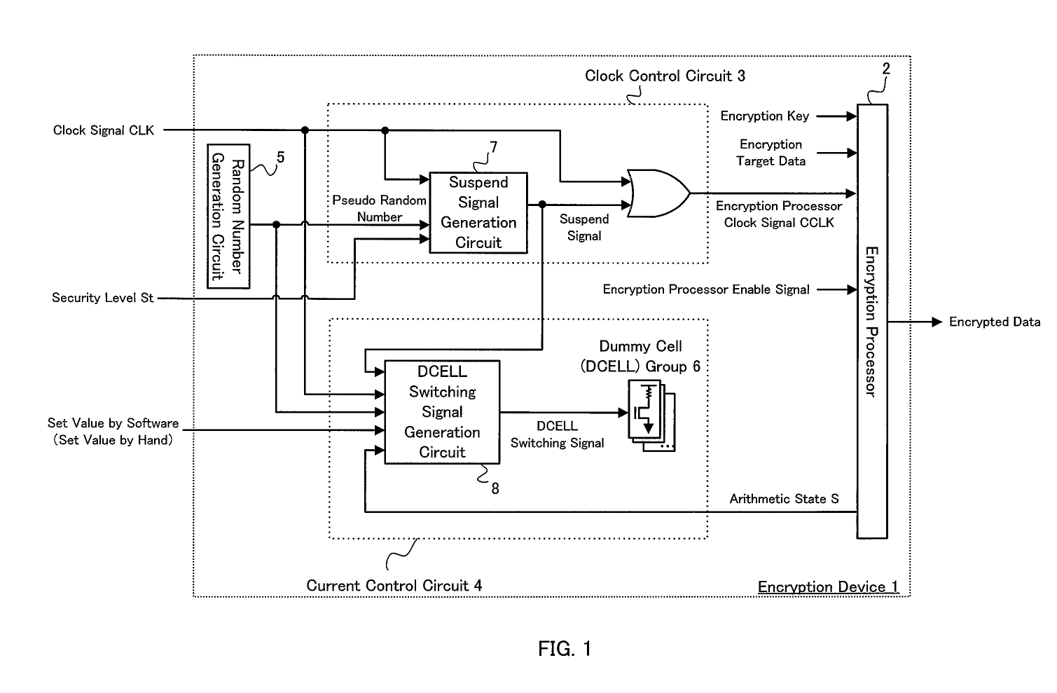

Embodiments of an encryption device according to the present invention (referred to as the “device of the present invention” occasionally hereinafter) will be described with reference to FIGS. 1 to 3 hereinafter.

### First Embodiment

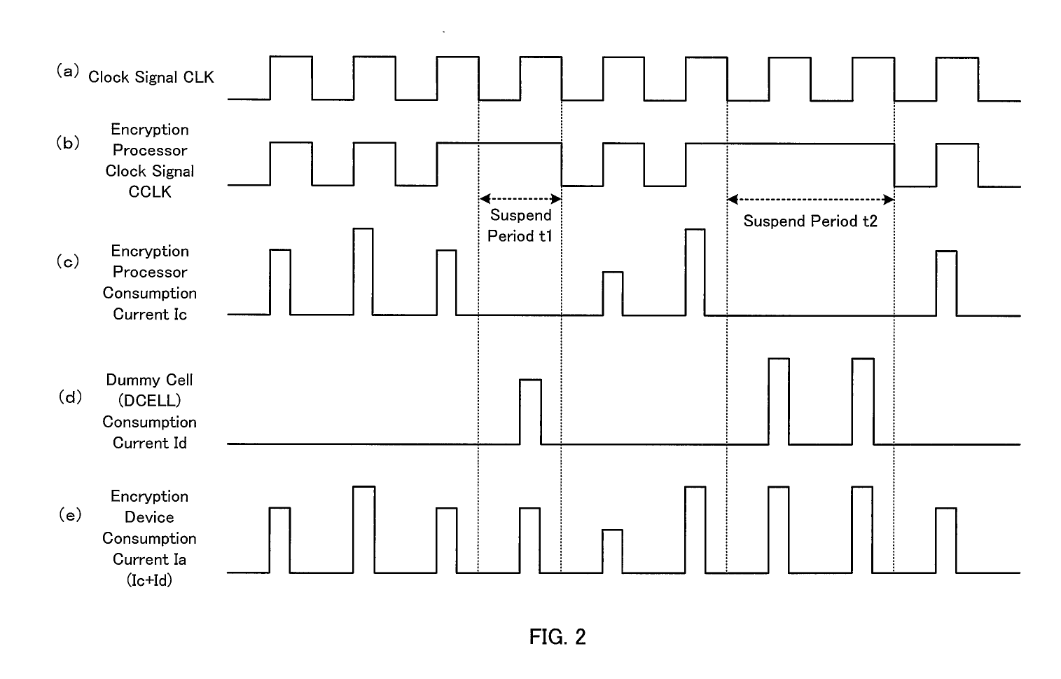

A first embodiment (referred to as “the present embodiment” occasionally hereinafter) of the device of the present invention will be described with reference to FIGS. 1 and 2.

FIG. 1 is a block diagram showing a schematic configuration in the present embodiment of the device of the present invention. As shown in FIG. 1, an encryption device 1 according to the present invention includes an encryption processor 2, a clock control circuit 3, a current control circuit 4, and a random number generation circuit 5.

The encryption processor 2 receives encryption target data to be encrypted, an encryption key to be used in encrypting the data, an encryption processor clock signal CCLK serving as a timing signal for the encryption, and an encryption processor enable signal for switching between an operation state and a non-operation state. The encryption processor 2 generates encrypted data by encrypting the encryption target data based on the encryption key, in synchronization with the encryption processor clock signal CCLK (for example, by detecting its rise and generating the encrypted data at the same timing of the rise) while the encryption processor enable signal shows an active state. This method for generating the encrypted data can be a general encryption method such as the DES system.

The clock control circuit 3 receives a clock signal and a pseudo-random number outputted from the random number generation circuit 5, and generates the encryption processor clock signal CCLK based on those, and outputs it to the encryption processor 2. In addition, as shown in FIG. 1, a security level St may be externally inputted thereto in addition to the clock signal and the pseudo-random number. The security level St shows an importance level of the encryption target data to be processed by the encryption processor 2 and can be externally set by a user. In addition, the security level St may be adjusted in the device 1 of the present invention.

More specifically, the clock control circuit 3 has a suspend signal generation circuit 7 therein, and the suspend signal generation circuit 7 latches and decodes the pseudo-random number generated in the random number generation circuit 5, based on the clock signal CLK. Then, based on the decoded result, the suspend signal generation circuit 7 determines whether or not a suspend process in which the clock signal is temporarily suspended is performed, and determines a suspend length showing how many cycles the clock signal CLK has from the time the suspend process is started until a resume process is started to cancel the suspended state, and outputs a suspend signal based on the above determination results. In addition, it is determined whether or not the suspend process is executed, based on suspend generation probability calculated based on the decoded result of the latched pseudo-random number.

At this time, in the case where the security level St is inputted, the suspend generation provability and the suspend length can be changed depending on the security level. For example, the suspend generation provability can be changed by changing the bit number of the pseudo-random number used for decoding, according to the security level.

More specifically, as the bit number of the pseudo-random number to be used for decoding is determined based on the security level St, when the suspend process is determined to be performed in the case where the value provided by decoding a target bit string satisfies a predetermined condition, the suspend generation provability can be changed depending on the security level. More specifically, according to the case where the suspend process is determined to be performed when only a specific one bit of the pseudo-random number is used for decoding and when the value is 1, and according to the case where the suspend process is determined to be performed when only specific two bits are used for decoding and when the values are all 1, the suspend generation provability is 50% in the former case, while the suspend generation provability is 25% in the latter case, so that a variation can be provided between them.

Also, regarding the suspend length, as the bit number of the pseudo-random number to be used for decoding is determined based on the security level St, when one predetermined suspend length is determined based on the value provided by decoding the target bit string, the suspend length can be changed depending on the security level. That is, when specific n bits of the pseudo-random number are used for decoding, since the suspend length can be 2ⁿ types of values. Thus, when the suspend lengths are related to the above values respectively, the range of the values of the suspend lengths can be determined. For example, when one specific bit of the pseudo-random number is used for decoding, the values can be two values such as 0 and 1, so that the suspend length can be set to 2 cycles when the value is 0, and the suspend length can be set to 4 cycles when the value is 1, or when two specific bits of the pseudo-random number are used for decoding, the values can be four values such as 00, 01, 10, and 11, so that the suspend length can be set to 1 cycle when the value is 00, 2 cycles when the value is 01, 3 cycles when the value is 10, and 4 cycles when the value is 11, whereby the suspend length can be changed according to the security level.

When the suspend signal generated described above is inputted to an OR circuit together with the clock signal, for example and the logical OR operation is performed, the encryption processor clock signal CCLK is generated.

That is, when it is assumed that the suspend signal that becomes active when the suspend process is executed is outputted from the suspend signal generation circuit 7, since the encryption processor clock signal CCLK is kept active while the suspend signal is in the active state, the encryption processor cannot recognize the rise (or fall) of the inputted encryption processor clock signal, so that the encryption processor 2 becomes the suspend state. Meanwhile, when the suspend signal showing the non-active state after the elapse of a predetermined time is outputted from the suspend signal generation circuit 7 to execute the resume process after being kept in the suspend state for a predetermined time, the encryption processor clock signal CCLK falls in response to the fall of the clock signal CLK, and the encryption processor clock signal rises again in response to the rise of the next clock signal CLK. Thus, the encryption processor 2 can detect the fall (or rise), the encryption operation can be performed again in the resume state.

In addition, when the security level St is not externally inputted, the suspend generation provability and the suspend length can be determined based on a predetermined certain security level.

The current control circuit 4 obtains an arithmetic state S serving as a state signal showing the operational state of the encryption processor 2 from the encryption processor 2, and adjusts a consumption current amount in the encryption device 1 based on the arithmetic state, and includes a DCELL (dummy cell) group 6 to adjust the consumption current amount substantially, and a DCELL switching signal generation circuit 8 to perform conduction/non-conduction control of each DCELL belonging to the DCELL group 6.

The DCELL switching signal generation circuit 8 receives the suspend signal generated from the suspend signal generation circuit 7, and the clock signal CLK as the timing signal, and latches the arithmetic state S of the encryption processor 2 with this clock signal CLK, and determines sequentially how much consumption current is generated in the encryption processor 2 to perform the arithmetic processing, and generates a DCELL switching signal based on the determination result and the suspend signal. The DCELL switching signal turns on (or off) the DCELLs, the number of which is predetermined based on the determination result, over the suspend period. According to the DCELL group 6, when the switching control is performed based on the DCELL switching signal, the designated number of DCELLs are turned on over the suspend period and the current is consumed in the corresponding DCELLs, so that the consumption current amount in the encryption device 1 is adjusted.

At this time, the DCELL switching signal generation circuit 8 preferably generates the DCELL switching signal showing the active state for a certain period of time to the DCELLs to be turned on, in synchronization with the rise or fall of the clock signal CLK.

In addition, the DCELL switching signal generation circuit 8 may generate the DCELL switching signal to turn on the DCELLs the number of which is predetermined based on the current consumption amount shown by the obtained arithmetic state S. In this case, the DCELL switching signal to turn on or off the DCELLs, the number of which is determined based on the arithmetic state S, is generated.

In addition, the DCELL switching signal generation circuit 8 does not necessarily generate the DCELL switching signal based on the value of the arithmetic state S, and when the suspend signal is active, that is, when the encryption processor 2 is not in operation, it may generate the DCELL switching signal to turn on the predetermined number of DCELLs. In this case, the DCELL switching signal generation circuit 8 generates the DCELL switching signal based on the value of the suspend signal, so that the DCELL switching signal to turn on or off the predetermined number of DCELLs is generated based on the value of the suspend signal.

According to the encryption processor 2, there is a difference in consumption current amount in the processor 2 between the encrypting operation state and the suspend state (there is a difference in consumption power accordingly). Especially, during the encrypting operation, when the encryption target data is latched, and when the encrypted data after the encrypting operation is outputted to the next-stage circuit, the consumption current amount is largely increased. Since the process is performed in synchronization with the encryption processor clock signal in the encryption processor 2 as described above, the above latch process and the encrypted data output process are generated in the vicinity of the rise or fall of the encryption processor clock signal. Therefore, the consumption current amount of the encryption processor 2 shows a peak value in the vicinity of the rising or the falling timing of the encryption processor clock signal.

As described above, the encryption processor clock signal is generated based on the clock signal CLK, and the rising timing of the encryption processor clock signal is in synchronization with the rising timing of the clock signal CLK. Meanwhile, while the encryption processor clock signal is in the suspend state, the consumption current amount is not increased at the time of the rising or falling timing of the clock signal CLK. Therefore, by synchronizing the DCELL switching signal generation circuit 8 with the rising or falling timing of the clock signal CLK and generating the DCELL switching signal that becomes active for a certain period, that is, only for the period in which the consumption current amount would show the peak value in the encryption processor 2, the consumption current is generated in the DCELL group 6 in accordance with the timing when the consumption current amount is supposed to be increased at the time of encrypting process, whereby the fact that the generation timing of the suspend is prevented from being estimated even when the reduction in consumption current amount is externally detected.

FIG. 2 is a timing chart showing variations in timing of the signals and current amounts in the device 1 of the present invention, in which FIG. 2(a) shows a waveform of the clock signal CLK, FIG. 2(b) shows the waveform of the encryption processor clock signal CCLK, FIG. 2(c) shows the waveform of the encryption processor consumption current Ic, FIG. 2(d) shows the waveform of the DCELL consumption current Id, and FIG. 2(e) shows the waveform of the consumption current Ia of the encryption device 1 as a whole.

As described above, according to the encryption processor 2, the encrypting operation process is performed in synchronization with the encryption processor clock signal CCLK, and the amount of the consumption current Ic is increased in this process. Meanwhile, since the encrypting operation process is not performed in the encryption processor 2 during the suspend period (periods t1 and t2 in FIG. 2), the consumption current Ic is not increased in the encryption processor 2 (see FIG. 2(c)).

However, since the current is consumed in the DCELL group 6 in synchronization with the clock signal CLK for this suspend period (t1 and t2), the DCELL consumption current Id is increased (see FIG. 2(d)), and as a result, the consumption current amount is increased in the device 1 of the present invention 1 even in the suspend period at the same timing as the case where the encrypting operation process is performed as a whole (see FIG. 2(e)). Thus, since the variation of the consumption current amount in the encrypting operation state and the variation of the consumption current amount in the suspend state can be almost at the same level, even when the variation of the consumption current amount is externally detected and the consumption current waveforms are aligned, it is difficult to estimate the generation timing of the suspend.

In addition, the set value to determine the number of circuits to be turned on in the DCELL group 6 may be externally inputted to the DCELL switching signal generation circuit 8 by software or by hand in the above embodiment as shown in FIG. 1. In addition, after the pseudo-random number is inputted from the random number generation circuit 5, the number of the circuits to be turned on varies to some extent based on the pseudo-random number. The same is true in the following second embodiment.

### Second Embodiment

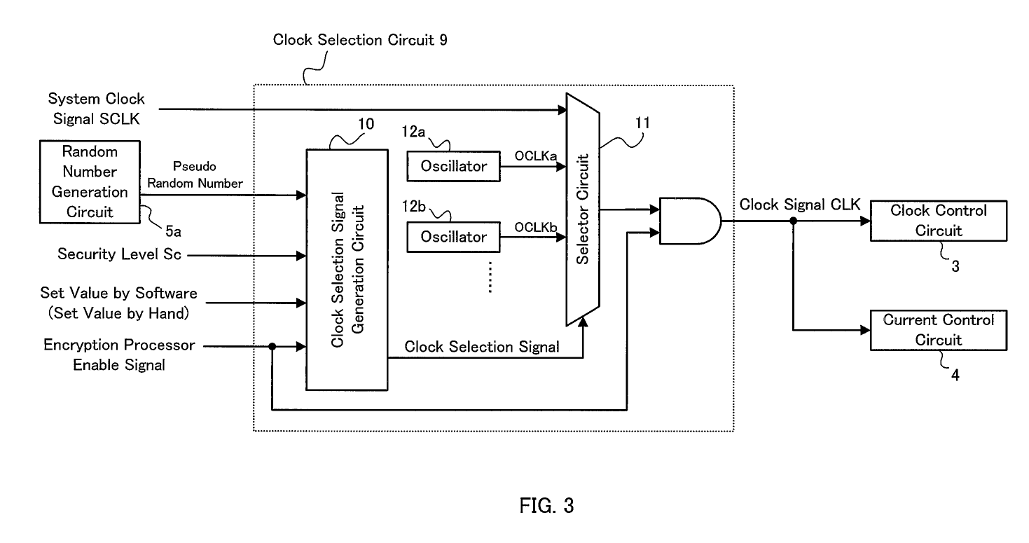

A description will be made of a second embodiment (referred to as “the present embodiment” occasionally hereinafter) of the device of the present invention with reference to FIG. 3. In addition, since the present embodiment is the same as the first embodiment except for a method for generating the clock signal CLK, a description will be made of a different part and the same components as the first embodiment will not be described.

FIG. 3 is a block diagram showing a schematic configuration of a clock selection circuit 9 to generate a clock signal CLK in the present embodiment.

The clock selection circuit 9 externally receives a system clock signal SCLK serving as a reference signal, a random number generation circuit 5a (that may be the same random number generation circuit as the random number generation circuit 5 in the first embodiment), and an encryption processor enable signal, and includes a clock selection signal generation circuit 10, a selector circuit 11, and one or more selecting clock generation circuits (expressed by “oscillators” in FIG. 3) 12a, 12b, . . . (referred to as the “selecting clock generation circuit 12” collectively hereinafter). In addition, the selecting clock generation circuits 12a, 12b, . . . output selecting clock signals OCLKa, OCLKb (referred to as the “selecting clock signal OCLK” collectively hereinafter) each having different frequency characteristics.

The clock selection circuit 9 selects one signal from the system clock signal SCLK and the selecting clock signals OCLK, and outputs the selected signal as the clock signal CLK to the clock control circuit 3 or the current control circuit 4. At this time, the selector circuit 11 selects one signal based on a clock selection signal applied from the clock selection signal generation circuit 10.

The clock selection signal generation circuit 10 detects the rise of the encryption processor enable signal, latches the pseudo-random number applied from the random number generation circuit 5a, decodes the pseudo-random number, generates a predetermined signal as the clock selection signal based on the decoded result, and outputs it.

The selector circuit 11 selects one signal from the system clock signal SCLK and selecting clock signals OCLK based on the clock selection signal, and outputs it to the next stage. In this configuration, the same clock signal CLK is constantly generated while the device 1 of the present invention is driven in which the encryption processor enable signal is kept in the active state. In addition, when an AND circuit to which the clock signal CLK outputted from the selector circuit 11 and the encryption processor enable signal are inputted is provided on the output side of the selector circuit 11, and the output signal of the AND circuit is applied to the clock control circuit 3 or the current control circuit 4, the clock signal CLK is prevented from being applied to the circuits 3 and 4 when the device 1 of the present invention is not in operation, so that the unnecessary consumption power can be prevented from being generated.

According to the above configuration, since the clock signal CLK varies at random every time the device 1 of the present invention is driven, the timing when the consumption current of the device 1 of the present invention is increased can vary at each time. Thus, even when the variation of the consumption current amount (or consumption power) is analyzed over a long period and the consumption current waveforms are aligned, it is difficult to estimate the generation timing of the suspend.

In addition, although the oscillator is used as the selecting clock signal generation circuit in the above embodiment, the selecting clock signal may be generated by dividing the system clock signal SCLK by a frequency divider.

In addition, as shown in FIG. 3, the clock selection signal generation circuit 10 receives a security level Sc (that may be the same signal as the security level St in the first embodiment), and the method for generating the clock selection signal may vary depending on the security level Sc. That is, the signal to be selected by the selector circuit 11 is decided based on the security level Sc.

For example, when the security level Sc is set high, one signal is selected from the system clock signal SCLK and all the selecting clock signals OCLK, and when the security level Sc is set low, one signal is selected from the system clock signal SCLK and the predetermined selecting clock signal (only the selecting clock signal OCLKa, for example). In this configuration, the variation range of the clock signal can be increased based on the security level, so that the more secured configuration can be provided. In addition, when the security level is lowest, that is, when the security is not needed, the configuration may be such that only the system clock signal SCLK is always selected, that is, the clock signal selection is not performed. In addition, when the security level Sc is not externally inputted in the above configuration, the clock selection signal may be generated based on a predetermined security level.

Furthermore, the set value to determine the clock selection signal may be externally inputted to the clock selection signal generation circuit 10 by software or by hand. In this case, the clock selection signal is generated in the clock selection signal generation circuit 10 based on the set value, or the set value and the pseudo-random number, or the set value, the pseudo-random number, and the security level.

In addition, although the description has been made of the case where the device 1 of the present invention is provided with the random number generation circuit 5 in the above embodiments, as another configuration, the device 1 of the present invention does not have the random generation circuit 5, but the pseudo-random number outputted from the random number generation circuit 5 existing outside the device 1 of the present invention may be inputted to the device 1 of the present invention.

### INDUSTRIAL APPLICABILITY

The present invention can be applied to the encryption device with enhanced function to prevent the encryption key from being decrypted by the consumption current analysis.

1. An encryption device comprising:
a clock control circuit adapted to receive a clock signal and a pseudo-random number, and perform a suspend process and a resume process to the clock signal based on the pseudo-random number to generate an encryption processor clock signal;
an encryption processor adapted to perform an encryption process to encryption target data in synchronization with the encryption processor clock signal; and
a current control circuit adapted to obtain an arithmetic state showing an operational state of the encryption processor to adjust a consumption current amount based on the arithmetic state.

2. The encryption device according to claim 1, wherein
the clock control circuit determines a suspend length and suspend generation provability of the clock signal based on the pseudo-random number.

3. The encryption device according to claim 2, wherein
the clock control circuit receives a security level of the encryption target data, and changes one or both determination methods of the suspend length and the suspend generation provability depending on the security level.

4. The encryption device according to claim 1 further comprising
a clock selection circuit adapted to output the clock signal, wherein
the clock selection circuit receives a reference system clock signal and the pseudo-random number, includes one or more selecting clock generation circuits adapted to generate an original selecting clock signal different from the system clock signal in response to the system clock signal or regardless of the system clock signal, selects any one signal from the one or more selecting clock signals and the system clock signal based on the pseudo-random number, and outputs the selected signal as the clock signal.

5. The encryption device according to claim 4, wherein
the clock selection circuit receives the security level, and
signals any one of which is to be selected as the clock signal are determined based on the security level.

6. The encryption device according to claim 1, wherein
the current control circuit has a plurality of dummy cells each having a switching element, and
the consumption current amount is adjusted by turning on the dummy cells a number of which is predetermined based on the arithmetic state.

7. The encryption device according to claim 1, wherein
the current control circuit adjusts the consumption current amount based on the arithmetic state and an externally set adjustment amount.

8. The encryption device according to claim 1, wherein
the current control circuit receives the pseudo-random number and adjusts the consumption current amount based on the arithmetic state and a value of the pseudo-random number.
